(19) United States
(12) Patent Application Publication
(10) Pub. No.: US 2003/0054842 A1
(43) Pub. Date: Mar. 20, 2003

(54) Methods and apparatus for simultaneously communicating voice and data in an analog cordless telephone system

(76) Inventors: Wilhelm Ernst Riedl, Indianapolis, IN (US); Hung Chi Lai, Indianapolis, IN (US); Kenneth Russell Mills, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 09/955,882

(22) Filed: Sep. 19, 2001

(51) Int. Cl. H04Q 7/20

(52) U.S. Cl. 455/462; 455/415; 455/566; 455/553

(57) ABSTRACT

A method of simultaneously communicating voice and data on the same channel in an analog cordless telephone system involves generating an analog signal from an audible voice signal during a cordless telephone call; generating a frequency shift keying (FSK) signal from digital data having a nominal frequency of about 20 KHz; summing the analog signal and the FSK signal to produce a composite analog and digital signal; modulating a radio frequency (RF) carrier with the composite analog and digital signal to produce a modulated RF carrier; and transmitting the modulated RF carrier. On the receiving end, the method involves receiving the modulated RF carrier during the call; demodulating the modulated RF carrier to reproduce the composite analog and digital signal; bandpass filtering the composite analog and digital signal to separate the analog signal and the FSK signal from one another; reproducing the audible voice signal from the analog signal; and detecting the digital data from the FSK signal and processing the digital data for display and control.

### BACKGROUND OF THE INVENTION

1. Field of the Invention

The present invention relates generally to cordless telephone systems, and more particularly to analog cordless telephone systems that provide for the simultaneous communication of voice and data on the same channel.

2. Description of the Related Art

A conventional analog cordless telephone system includes a cordless base unit and a cordless telephone unit which communicate via radio frequency (RF) signals. For communicating voice information between the units, the conventional analog cordless system utilizes analog signaling, such as frequency modulation (FM), over a voice channel. For communicating data, such as commands involving security, number dialing, caller identification (ID), and channel numbers, the conventional analog cordless system utilizes digital signaling over the voice channel.

When the digital signaling is sent over the voice channel during a telephone call, a speaker in the cordless telephone unit is muted so that the end-user does not hear the digital signaling. Although this muting desirably eliminates the sound of digital signaling through the speaker, it temporarily mutes the voice of the other party during the call as well. This is perceived as a nuisance by the end-user of the cordless telephone unit.

Accordingly, what are needed are methods for simultaneously communicating voice and data on the same channel in an analog cordless telephone system that eliminate the sound of the digital signaling received during a call but that do not adversely affect the telephone conversation.

### SUMMARY OF THE INVENTION

An inventive method of simultaneously communicating voice and data in an analog cordless telephone system involves generating an analog signal from an audible voice signal during a cordless telephone call; modulating a carrier with digital data to produce a digitally modulated signal; summing the analog signal and the digitally modulated signal to produce a composite analog and digital signal; modulating a radio frequency (RF) carrier with the composite analog and digital signal to produce a modulated RF carrier; and transmitting the modulated RF carrier. On the receiving end, the method involves receiving the modulated RF carrier during the call; demodulating the modulated RF carrier to reproduce the composite analog and digital signal; filtering the composite analog and digital signal to separate the analog signal and digitally modulated signal from one another; reproducing the audible voice signal from the analog signal; and detecting the digital data from the digitally modulated signal for display or control in the cordless telephone system. The digital data may be any suitable data for control and/or display purposes; for example, caller identification (ID) data, channel number data, text message data, or key selection data.

An inventive analog cordless telephone system includes a cordless base unit and a cordless telephone unit. Each unit has a transmitting portion and a receiving portion. The transmitting portion includes a first audio circuit which produces a first analog signal from a first audible voice signal during a cordless telephone call; a first modulator which generates a first digitally modulated signal from first digital data; a summer circuit which sums the first analog signal and the first digitally modulated signal to produce a first composite analog and digital signal; a second modulator which modulates a first RF carrier with the first composite analog and digital signal to produce a first modulated RF carrier; and a transmitter which transmits the first modulated RF carrier. The first digital data may be any suitable data for control and/or display purposes; for example, caller ID data, text message data, channel number data, or key selection data. The receiving portion includes a receiver which receives a second modulated RF carrier during the call; a demodulator which demodulates the second modulated RF carrier to produce a second composite analog and digital signal; a filter which filters the second composite analog and digital signal to separate a second analog signal and a second digitally modulated signal from one another; an audio circuit which produces a second audible voice signal from the second analog signal; a detector which detects second digital data from the second digitally modulated signal; a processor which processes the second digital data for display or control in the cordless unit; and a speaker which remains unmuted during receipt of the second digital data.

### BRIEF DESCRIPTION OF THE DRAWINGS

FIG. 1 is a schematic block diagram of an analog cordless telephone system of the present invention;

FIG. 2 is a schematic block diagram of a cordless telephone unit of the analog cordless telephone system of FIG. 1;

FIG. 3 is a schematic block diagram of a transmitting portion of the cordless telephone unit of FIG. 2;

FIG. 4 is a detailed schematic diagram of a modulator of FIG. 3;

FIG. 5 is a schematic block diagram of a receiving portion of the cordless telephone unit of FIG. 2;

FIG. 6 is a detailed schematic diagram of a filter and a detector of FIG. 5;

FIG. 7 is a flowchart describing a method of simultaneously transmitting voice and data on the same channel in the analog cordless telephone system of FIG. 1; and

FIG. 8 is a flowchart describing a method of simultaneously receiving the voice and data on the same channel in the analog cordless telephone system of FIG. 1.

### DETAILED DESCRIPTION OF THE PREFERRED EMBODIMENTS

According to the present invention, a method of simultaneously communicating voice and data on the same channel in an analog cordless telephone system involves generating an analog signal from an audible voice signal during a cordless telephone call; modulating a carrier with digital data to produce a digitally modulated signal; summing the analog signal and the digitally modulated signal to produce a composite analog and digital signal; modulating a radio frequency (RF) carrier with the composite analog and digital signal to produce a modulated RF carrier; and transmitting the modulated RF carrier. On the receiving end, the method involves receiving the modulated RF carrier during the call; demodulating the modulated RF carrier to reproduce the composite analog and digital signal; filtering the composite analog and digital signal to separate the analog signal and digitally modulated signal; reproducing the audible voice signal from the analog signal; and detecting the digital data from the digitally modulated signal for display or control in the cordless telephone system. The digital data may be any suitable data for control and/or display purposes; for example, caller identification (ID) data, text message data, channel number data, or key selection data.

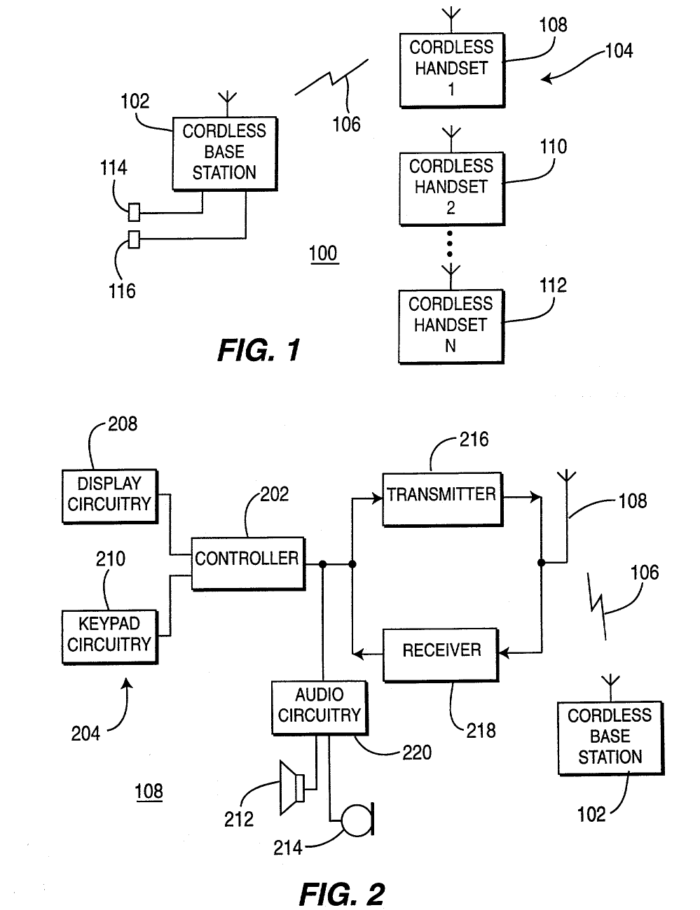

FIG. 1 is a schematic block diagram of an analog cordless telephone system 100 of the present invention. Cordless telephone system 100 includes a cordless base station 102, which may be referred to as a cordless base unit, and a cordless handset 108, which may be referred to as a cordless telephone unit. Cordless base station 102 and cordless handset 108 communicate with each other via radio frequency (RF) signals 106. Cordless base station 102 has an interface for coupling to an alternating current (AC) power source 114, such as that commonly provided in a home residence or business. Cordless base station 102 also has an interface for coupling to a land line 116, which couples cordless base station 102 to a public switched telephone network (PSTN) for land line telephone communication. Cordless handset 108 may be one handset of a plurality of cordless handsets 104 utilized in connection with cordless base station 102. As shown in FIG. 1, the plurality of cordless handsets 104 include cordless handsets 108-112, designated as cordless handsets 1 through N in FIG. 1.

FIG. 2 is a schematic block diagram of cordless telephone unit 108 of analog cordless telephone system 100 of FIG. 1. Cordless telephone unit 108 of FIG. 2 includes common electrical components such as a controller 202, user interface circuitry 204, and transceiver circuitry 206. User interface circuitry 204 includes display circuitry 208 for use in connection with a visual display, keypad circuitry 210 for use in connection with a keypad, and audio circuitry 220 for use in connection with a speaker 212 and a microphone 214. Transceiver circuitry 206 uses RF techniques for communication and, in particular, frequency modulation (FM) techniques. Preferably, transceiver circuitry 206 utilize FM techniques in the 900 MHz or 2.4 GHz Industrial, Scientific, and Medical (ISM) bands. Transceiver circuitry 206 includes a transmitter 216, a receiver 218, and an antenna 108. Although it is stated that the schematic block diagram is for cordless handset 108, similar or the same circuitry is utilized in cordless base station 102 as well as other cordless handsets 104.

Basic operation of cordless handset 108 is now described. When an end-user of cordless handset 108 is engaged in a telephone call, the end-user speaks or conveys audible voice signals into microphone 214 which provides low-level analog signals to audio circuitry 220 for processing the information. This information is conveyed to transmitter 216 and transmitted through antenna 108 via RF signals to cordless base station 102. On the other hand, cordless handset 108 receives RF signals through antenna 108 and receiver 218 which processes them and provides them to audio circuitry 220. Audio circuitry 220 processes these signals and provides them to speaker 212 which generates audible voice signals for the end-user. Controller 202 provides general control over receiver 218, transmitter 216, and audio circuitry 220 as needed.

The keypad which is used with keypad circuitry 210 typically includes conventional telephone keys (i.e., dual-tone multiple frequency or DTMF keys 0-9, *, and #) as well as control keys. The end-user initiates telephone calls by pressing the keys of the keypad, where keypad circuitry 210 uniquely detects each key that is pressed and provides this information to controller 202. This information may be referred to as key selection data. Controller 202 then passes this DTMF key selection data to transmitter 216 in suitable form so that it can be transmitted from antenna 108 to cordless base station 102. In response, cordless base station 102 generates DTMF tones based on the DTMF key selection data for originating the telephone call. The DTMF keys may also be pressed by the end-user during a telephone call, such as when the end-user needs to enter a personal identification number (PIN) to retrieve voice mail. The keypad is used for other reasons as well, such as for changing the channel that cordless base station 102 and handset 108 use for communications.

The visual display which is used with display circuitry 208 confirms the identification of the keys that were pressed by visually displaying them upon actuation. The visual display also displays other useful information to the end-user, such as caller identification (ID) information, the current date and time, the current channel number, and text message data for visual display. The caller ID information, for example, is transmitted to cordless handset 108 from cordless base station 102 when a telephone call over the PSTN is received. Controller 202 receives such data from receiver 218 and passes it in suitable form to display circuitry 208 for display. Similarly, text message data can be sent to and from telephones similar to electronic-mail (e-mail) messaging or short messaging, and may include messages relating to, for example, weather and sports.

Referring now to the present invention, the simultaneous communication of both data and voice over an analog cordless telephone channel is generally realized by splitting the existing baseband channel into separate portions. In a particular embodiment described herein, a portion of the spectrum from about 300-3,300 Hz is dedicated to audio/voice communication and a portion of the spectrum from about 10-30 KHz is dedicated to the communication of other information, namely digital data. More particularly, the preferred embodiment has a data channel residing at about 20 KHz and having a bandwidth of about 2 KHz; this data channel preferably utilizes a frequency shift keying (FSK) modulated tone having a center frequency of about 20 KHz. It is understood that the spectrum from 5-10 KHz could also be utilized for the digital data. However, this part of the spectrum would require more rigorous filtering and expense.

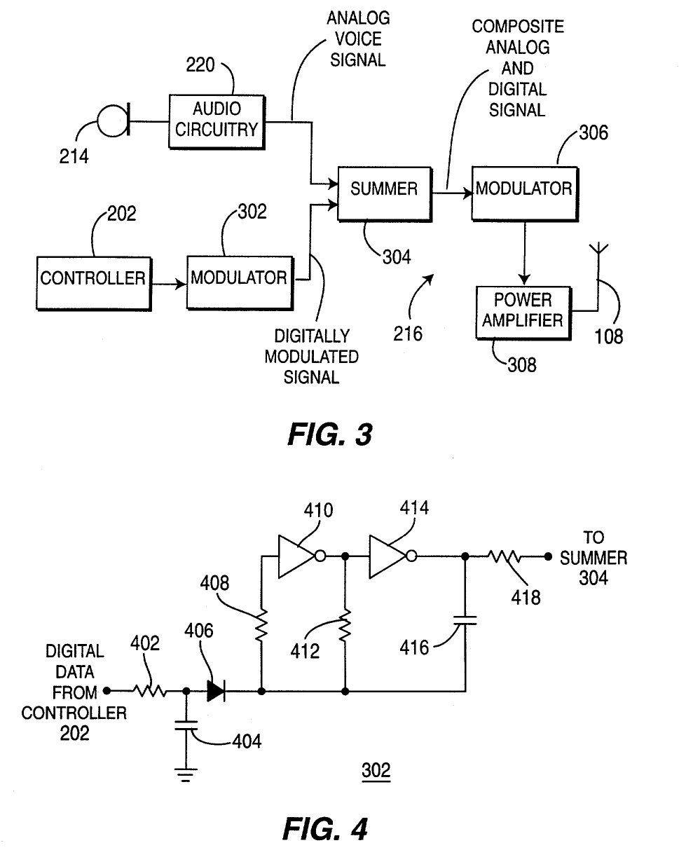

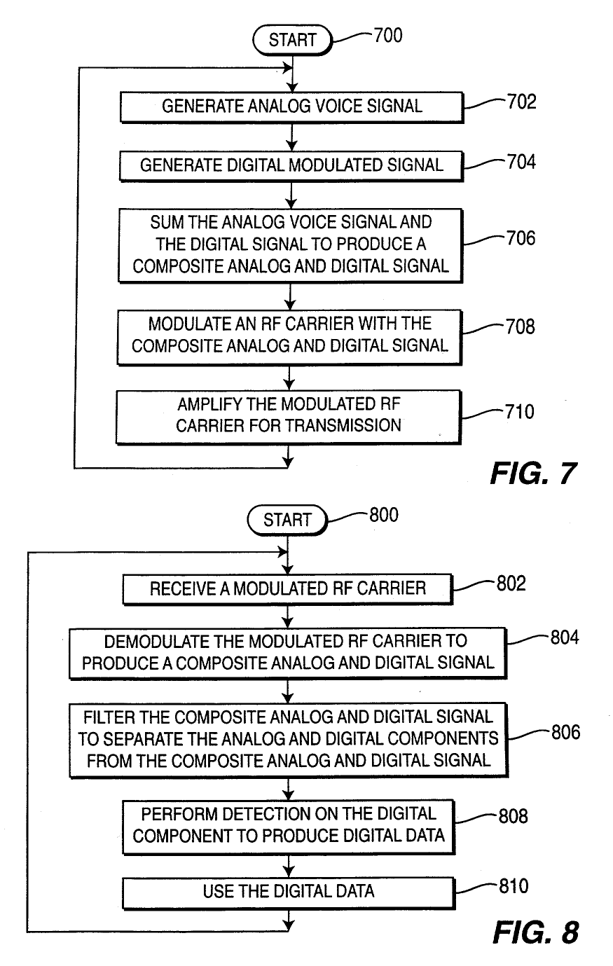

FIG. 3 is a schematic block diagram of a transmitting portion of cordless telephone unit 108 of FIG. 2. The transmitting portion includes microphone 214, audio circuitry 220, controller 202, a modulator 302, a summer circuit 304, a modulator 306, a power amplifier 308, and antenna 108. The transmitting portion is configured to operate in the 900 MHz or 2.4 GHz ISM bands. FIG. 3 will now be described in more detail in combination with FIG. 7, which is a flowchart describing a method of simultaneously transmitting voice and data on the same channel in such a system.

Referring to FIGS. 2 and 7 in combination, and beginning at a start block 700 of FIG. 7, the end-user speaks and provides an audible voice signal into microphone 214 during a cordless telephone call. Audio circuitry 220 receives a low-level signal from microphone and processes it to generate an analog voice signal (step 702) which is conveyed to summer circuitry 304. Controller 202 generates digital data at the same time that the analog voice signal is generated, and passes this digital data to modulator 302. The digital data may be any suitable data for display and/or control; for example, the digital data may be caller ID data, text message data, or key selection data.

Modulator 302 modulates a carrier signal with the digital data to produce a digitally modulated signal (step 704). Generally, this digitally modulated signal has a nominal frequency that is greater than or equal to 10 KHz. Preferably, the digitally modulated signal has a center frequency of about 20 KHz and a bandwidth of about 2 KHz. The digitally modulated signal is passed to summer circuitry 304 which sums the digitally modulated signal with the analog signal from audio circuitry 220 to produce a composite analog and digital signal at its output (step 706). The composite analog and digital signal modulates an RF carrier signal in modulator 306 to produce a modulated RF carrier signal (step 708). The modulated RF carrier is then amplified by power amplifier 308 (step 710) and transmitted via antenna 108.

Referring now to FIG. 4, a detailed schematic diagram of modulator 302 of FIG. 3 is shown. In this embodiment, modulator 302 is an FSK signal generator. As shown, modulator 302 of FIG. 4 uses an astable multivibrator realized with two inverters, an inverter 410 and an inverter 414, dimensioned to produce a square wave having a nominal frequency of 20 KHz. FSK is performed using the digital data from controller 202 and a capacitance that is switched in and out with a diode switch involving a diode 406. This circuitry is particularly advantageous in that it provides a simple, low-cost, good performance solution.

In this particular implementation, modulator 302 of FIG. 4 includes a resistor 402 having a first end coupled to controller 202 and a second end coupled to a first end of a capacitor 404. A second end of capacitor 404 is coupled to ground. The second end of resistor 402 and the first end of capacitor 404 are coupled to a first end of diode 406, which has a second end coupled to first ends of a resistor 408, a resistor 412, and a capacitor 416. Inverter 410 has an input coupled to a second end of resistor 408 and an output coupled to a second end of resistor 412. Inverter 414 has an input coupled to the second end of resistor 412 and the output of inverter 410, and an output coupled to a second end of capacitor 416. A resistor 418 has a first end coupled to the output of inverter 414 and a second end of capacitor 416, and a second end which is for coupling to summer 304. Exemplary values of the components of FIG. 4 are as follows: resistor 402=10 KΩ; capacitor 404=0.033 μF; resistor 408=1 KΩ; resistor 412=3.3 KΩ; capacitor 416=0.01 μF; and resistor 418=820 KΩ.

As was confirmed by testing and analysis, the square waves generated by modulator 302 caused no problem in terms of sub-harmonics and intermodulation products with analog voice signals. In an alternate embodiment, modulator 302 generates an FSK signal which more closely approximates a sine wave. The sine wave signal is implemented by filtering the multivibrator output prior to RF modulation, or by using other well-known sine wave generation techniques.

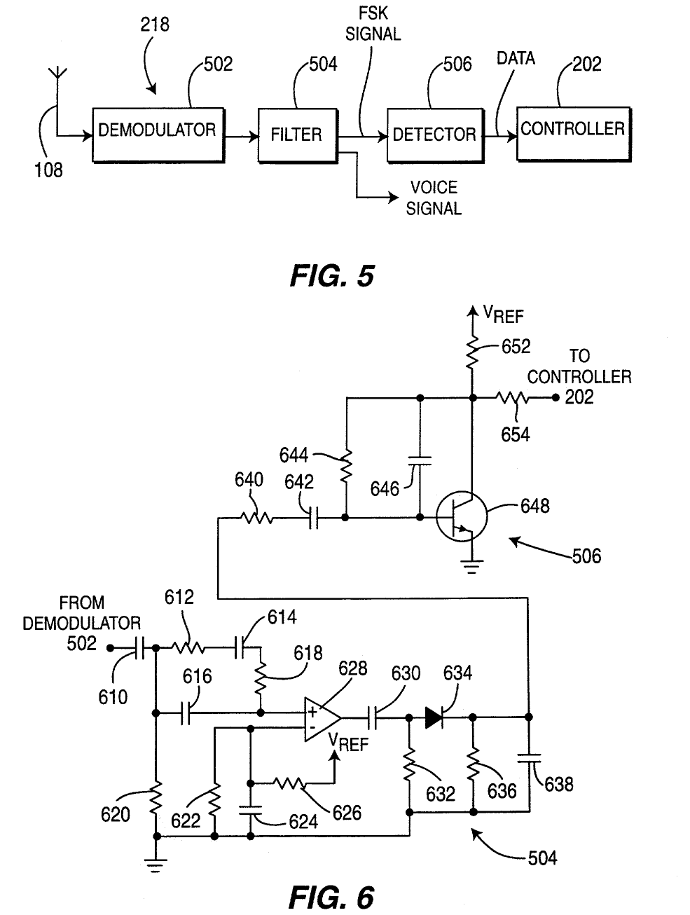

FIG. 5 is a schematic block diagram of a receiving portion of cordless telephone unit 108 of FIG. 2. The receiving portion includes antenna 108, a demodulator 502, a filter 504, a detector 506, and controller 202. The receiving portion is configured to operate in the 900 MHz or 2.4 GHz ISM bands. FIG. 5 will now be described in more detail in combination with FIG. 8, which is a flowchart describing a method of simultaneously receiving voice and data on the same channel in such a system.

Referring to FIGS. 5 and 8 in combination, and beginning at a start block 800 of FIG. 8, a modulated RF carrier signal is received via antenna 108 (step 802). This modulated RF signal is demodulated by demodulator 502 (step 804) to produce a composite analog and digital signal. The composite analog and digital signal is filtered by filter 504 to separate an analog signal and a digitally modulated signal from one another (step 806). Preferably, this filtering is performed by a bandpass filter having a center frequency of about 20 KHz and a bandwidth of about 2 KHz, to obtain a nominal 20 KHz FSK tone which carries digital data. Detector 506 detects digital data from the FSK tone (step 808). The digital data may be any suitable data for display and/or control; for example, the digital data may be caller ID data, text message data, channel number data, or key selection data. The digital data is passed to controller 202 which uses the data for the display and/or control purposes (step 810).

Referring now to FIG. 6, a detailed schematic diagram of filter 504 and detector 506 of FIG. 5 is shown. In this embodiment, filter 504 of FIG. 6 is a 20 KHz active bandpass filter and detector 506 is an envelope detector. Filter 504 has a Q and shape factor that allows for slope detecting the FSK signal. The circuitry of FIG. 6 is advantageous in that it provides a simple, low-cost, good performance solution. However, other techniques may be utilized, such as those detection schemes employing a phase locked loop (PLL).

In this particular implementation, filter 504 of FIG. 6 utilizes a capacitor 610 having a first end coupled to an output of demodulator 502 and a second end coupled to a first end of resistor 612. Resistor 612 has a second end coupled to a first end of a capacitor 614, a first end of a capacitor 616, and a first end of a resistor 620. Resistor 620 has a second end coupled to ground. Capacitor 614 has a second end coupled to a first end of a resistor 618. Capacitor 616 has a second end coupled to a second end of resistor 618, and these second ends are both coupled to a first input of operational amplifier 628. A second input of operational amplifier 628 is coupled to a first end of a resistor 626, a first end of a resistor 622, and a first end of a capacitor 624. Resistor 626 has a second end coupled to a reference voltage. Second ends of resistor 622 and capacitor 624 are coupled to ground. An output of operational amplifier 628 is coupled to a first end of a capacitor 630, which has a second end coupled to a first end of a resistor 632 and a first end of a diode 634. A second end of diode 634 is coupled to a first end of a resistor 636 and a first end of a capacitor 638; second ends of resistor 632, resistor 636, and capacitor 638 are coupled to ground. The first end of capacitor 638 is the output of filter 504.

Envelope detector 506 of FIG. 6 utilizes a resistor 640 having a first end coupled to the output of filter 504 and a second end coupled to a first end of a capacitor 642. The second end of capacitor 642 is coupled to a first end of a resistor 644, a first end of a capacitor 646, and a base of a transistor 648. A collector of transistor 648 is coupled to second ends of resistor 644 and capacitor 646 as well as to first ends of a resistor 652 and a resistor 654. A second end of resistor 652 is coupled to the reference voltage and a second end of resistor 654 is coupled to controller 202. The second end of resistor 654 is the output of detector 506.

Exemplary values of the components in FIG. 6 are as follows: capacitor 610=0.01 μF; resistor 612=15 KΩ; capacitor 614=270 pF; capacitor 616=270 pF; resistor 618=680 KΩ; resistor 620=1.8 KΩ; resistor 622=2 MΩ; capacitor 624=0.1 μF; resistor 626=2 MΩ; capacitor 630=0.1 μF; resistor 632=2 KΩ; resistor 636=1.5 KΩ; capacitor 638=0.068 μF; resistor 640=2.2 KΩ; capacitor 642=3.3 μF; resistor 644=150 KΩ; capacitor 646=680 pF; resistor 652=47 Ω; resistor 654=10 KΩ; and reference voltage=3.6 volts (cordless handset) and 5.0 volts (cordless base).

With use of the present invention, cordless telephone system 100 of FIG. 1 does not include the functionality to mute the audio path of cordless handset 108 when digital signaling is conveyed during a telephone call. No commands to mute are issued and no muting procedures take place when the digital signaling is conveyed. Thus, speaker 212 remains unmuted during receipt of the digital data. One exception to this, however, is where cordless handset 108 changes the channel during a telephone call.

Thus, the simultaneous use of both data and voice over an analog cordless telephone channel is realized by splitting the existing baseband channel into separate portions. In a particular embodiment, a portion of the spectrum from about 300-3,300 Hz is dedicated to audio/voice communication and a portion of the spectrum from about 10-30 KHz is dedicated to the communication of other information, namely digital data. The preferred embodiment has a data channel residing at about 20 KHz and a bandwidth of about 2 KHz; this data channel preferably utilizes an FSK modulated tone having a center frequency of about 20 KHz. It is understood that the spectrum from 5-10 KHz could also be utilized for the digital data. However, this part of the spectrum would require more rigorous filtering and expense.

As described herein, an inventive method of simultaneously communicating voice and data on the same channel in an analog cordless telephone system involves generating an analog signal from an audible voice signal during a cordless telephone call; modulating a carrier with digital data to produce a digitally modulated signal; summing the analog signal and digitally modulated signal to produce a composite analog and digital signal; modulating an RF carrier with the composite analog and digital signal to produce a modulated RF carrier; and transmitting the modulated RF carrier. On the receiving end, the inventive method involves receiving the modulated RF carrier during the call; demodulating the modulated RF carrier to reproduce the composite analog and digital signal; filtering the composite analog and digital signal to separate the analog signal and digitally modulated signal from one another; reproducing the audible voice signal from the analog signal; detecting the digital data from the digitally modulated signal; and processing the digital data for display or control in the cordless telephone system. The digital data may be any suitable data for control and/or display; for example, caller ID data, text message data, or key selection data.

An inventive analog cordless telephone system includes a cordless base unit and a cordless telephone unit. Each unit has a transmitting portion and a receiving portion. The transmitting portion includes a first audio circuit which produces a first analog signal from a first audible voice signal during a cordless telephone call; a first modulator which modulates a carrier with first digital data to produce a digitally modulated signal; a summer circuit which sums the first analog signal and the first digitally modulated signal to produce a first composite analog and digital signal; a second modulator which modulates a first RF carrier with the first composite analog and digital signal to produce a first modulated RF carrier; and a transmitter which transmits the first modulated RF carrier. The first digital data may be, for example, caller ID data, text message data, or key selection data. The receiving portion includes a receiver which receives a second modulated RF carrier during the call; a demodulator which demodulates the second modulated RF carrier to produce a second composite analog and digital signal; a filter which filters the second composite analog and digital signal to separate a second analog signal and a second digitally modulated signal from one another; an audio circuit which produces a second audible voice signal from the second analog signal; a detector which detects second digital data from the second digitally modulated signal; a processor which processes the second digital data for display or control in the cordless unit; and a speaker which remains unmuted during receipt of the second digital data.

It is to be understood that the above is merely a description of preferred embodiments of the invention and that various changes, alterations, and variations may be made without departing from the true spirit and scope of the invention as set for in the appended claims. For example, the circuits described in relation to FIGS. 4 and 6 are merely examples of what can be utilized to practice the present invention; other configurations may be implemented as one skilled in the art will readily understand. Although the diagrams may be described as applying to the cordless handset, similar or the same circuitry is utilized in the cordless base station, and preferably both units have the same or similar components. None of the terms or phrases in the specification and claims has been given any special particular meaning different from the plain language meaning to those skilled in the art, and therefore the specification is not to be used to define terms in an unduly narrow sense.

What is claimed is:

1. A method of simultaneously communicating voice and data in a cordless telephone system, the method comprising the acts of:
generating an analog signal from an audible voice signal during a cordless telephone call;
generating a digitally modulated signal from digital data during the cordless telephone call;
summing the analog signal and the digitally modulated signal to produce a composite analog and digital signal;
modulating a radio frequency (RF) carrier with the composite analog and digital signal to produce a modulated RF carrier; and
transmitting the modulated RF carrier.

2. The method of claim 1, wherein the digital data comprise caller identification (ID) data.

3. The method of claim 1, wherein the digital data comprise text message data for visual display.

4. The method of claim 1, wherein the act of generating the digitally modulated signal comprises generating a frequency shift keying (FSK) signal.

5. The method of claim 1, wherein the act of generating the analog signal comprises generating an analog signal having frequencies within the range 500-5,000 Hz, and the act of generating the digitally modulated signal comprises generating a digital signal having a nominal frequency within the range 10-30 KHz.

6. A method of simultaneously communicating voice and data in a cordless telephone system, the method comprising the acts of:
receiving a modulated radio frequency (RF) carrier during a cordless telephone call;
demodulating the modulated RF carrier to produce a composite analog and digital signal;
filtering the composite analog and digital signal to separate an analog signal and a digitally modulated signal from one another;
producing an audible voice signal from the analog signal; and
detecting digital data from the digitally modulated signal and processing the digital data for display or control in the cordless telephone system.

7. The method of claim 6, wherein the digital data comprise caller identification (ID) data.

8. The method of claim 6, wherein the digital data comprise text message data for visual display.

9. The method of claim 6, wherein the act of detecting digital data comprises detecting digital data from a frequency shift keying (FSK) signal.

10. The method of claim 6, wherein the analog signal has frequencies within the range 500-5,000 Hz, and the digitally modulated signal has a nominal frequency within the range 10-30 KHz.

11. A cordless telephone device, comprising:
an audio circuit which produces an analog signal from an audible voice signal during a cordless telephone call;
a first modulator which modulates a carrier with digital data to produce a digitally modulated signal;
a summer circuit which sums the analog signal and the digitally modulated signal to produce a composite analog and digital signal;
a second modulator which modulates a radio frequency (RF) carrier with the composite analog and digital signal to produce a modulated RF carrier; and
a transmitter which transmits the modulated RF carrier.

12. The cordless telephone device of claim 11, the cordless telephone device comprising a cordless telephone unit.

13. The cordless telephone device of claim 11, the cordless telephone device comprising a cordless base station.

14. The cordless telephone device of claim 11, wherein the digital data comprise caller identification (ID) data.

15. The cordless telephone device of claim 11, wherein the digital data comprise text message data for visual display.

16. The cordless telephone device of claim 11, wherein the first modulator which produces the digitally modulated signal produces a frequency shift keying (FSK) signal.

17. The cordless telephone device of claim 11, wherein the audio circuit which produces the analog signal produces an analog signal having frequencies within the range 500-5,000 Hz, and the first modulator which produces the digitally modulated signal produces a digitally modulated signal having a nominal frequency within the range 10-30 KHz.

18. A cordless telephone device, comprising:
a receiver which receives a modulated radio frequency (RF) carrier during a cordless telephone call;
a demodulator which demodulates the modulated RF carrier to produce a composite analog and digital signal;
a filter which filters the composite analog and digital signal to separate an analog signal and a digitally modulated signal from one another;
an audio circuit which produces an audible voice signal from the analog signal;
a detector which detects digital data from the digitally modulated signal;
a processor which processes the digital data for display or control in the cordless telephone device; and
a speaker which remains unmuted during receipt of the digital data.

19. The cordless telephone device of claim 18, the cordless telephone device comprising a cordless telephone unit.

20. The cordless telephone device of claim 18, the cordless telephone device comprising a cordless base station.

21. The cordless telephone device of claim 18, wherein the digital data comprise caller identification (ID) data.

22. The cordless telephone device of claim 18, wherein the digital data comprise text message data for visual display.

23. The cordless telephone device of claim 18, wherein the detector detects digital data from a digitally modulated signal comprising a frequency shift keying (FSK) signal.

24. The cordless telephone device of claim 18, wherein the analog signal has frequencies within the range 500-5,000 Hz, and the digital signal has a nominal frequency within the range 10-30 KHz.

25. A cordless telephone device, comprising:
a transmitting portion including:
a first audio circuit which produces a first analog signal from a first audible voice signal during a cordless telephone call;
a frequency shift keying (FSK) signal generator which generates a first FSK signal from first digital data during the cordless telephone call;
a summer circuit which sums the first analog signal and the first FSK signal to produce a first composite analog and digital signal;
a radio frequency (RF) modulator which modulates a first RF carrier with the first composite analog and digital signal to produce a first modulated RF carrier;
a transmitter which transmits the first modulated RF carrier;
a receiving portion including:
a receiver which receives a second modulated RF carrier during the cordless telephone call;
a demodulator which demodulates the second modulated RF carrier to produce a second composite analog and digital signal;
a bandpass filter which filters the second composite analog and digital signal to separate a second analog signal and a second FSK signal from one another;
a second audio circuit which produces a second audible voice signal from the second analog signal;
an envelope detector which detects second digital data from the second FSK signal;
a processor which processes the second digital data for display and control of the cordless telephone device; and
a speaker which remains unmuted during receipt of the second digital data.
